(19) United States
(12) Patent Application Publication
(10) Pub. No.: US 2021/0150042 A1
(43) Pub. Date: May 20, 2021

(54) Protecting information embedded in a machine learning model

(71) Applicant: International Business Machines Corporation, Armonk, NY (US)

(72) Inventors: Jialong Zhang, White Plains, NY (US); Frederico Araujo, White Plains, NY (US); Teryl Taylor, Danbury, CT (US); Marc Phillipe Stoecklin, White Plains, NY (US); Benjamin James Edwards, Ossining, NY (US); Ian Michael Molloy, Westchester, NY (US)

(73) Assignee: International Business Machines Corporation, Armonk, NY (US)

(21) Appl. No.: 16/685,474

(22) Filed: Nov. 15, 2019

(51) Int. Cl. G06F 21/62; H04L 9/08; G06F 17/16; G06N 20/00

(52) U.S. Cl. CPC G06F 21/6209; G06N 20/00; G06F 17/16; H04L 9/0861

(57) ABSTRACT

A neural network is trained using a training data set, resulting in a set of model weights, namely, a matrix X, corresponding to the trained network. The set of model weights is then modified to produce a locked matrix X′, which is generated by applying a key. In one embodiment, the key is a binary matrix {0, 1} that zeros (masks) out certain neurons in the network, thereby protecting the network. In another embodiment, the key comprises a matrix of sign values {−1, +1}. In yet another embodiment, the key comprises a set of real values. Preferably, the key is derived by applying a key derivation function to a secret value. The key is symmetric, such that the key used to protect the model weight matrix X (to generate the locked matrix) is also used to recover that matrix, and thus enable access to the model as it was trained.

### BACKGROUND

### Technical Field

This disclosure relates generally to information security and, in particular, to protecting machine learning models against wrongful reproduction, distribution and use.

### Background of the Related Art

Machine learning technologies, which are key components of state-of-the-art Artificial Intelligence (AI) services, have shown great success in providing human-level capabilities for a variety of tasks, such as image recognition, speech recognition, and natural language processing, and others. Most major technology companies are building their AI products and services with deep neural networks (DNNs) as the key components. Building a production-level deep learning model is a non-trivial task, which requires a large amount of training data, powerful computing resources, and human expertise. For example, Google's Inception v4 model is a cutting edge Convolutional Neural Network designed for image classification; creation of a model from this network takes from several days to several weeks on multiple GPUs with an image dataset having millions of images. In addition, designing a deep learning model requires significant machine learning expertise and numerous trial-and-error iterations for defining model architectures and selecting model hyper-parameters.

As deep learning models are more widely-deployed and become more valuable, they are increasingly targeted by adversaries, who can steal the models (e.g., via malware or insider attacks) and then seek to benefit from their wrongful use. In particular, once a model is stolen, it is easy for the attacker to setup a plagiarizing or plagiarized service with the stolen model. Such actions (theft, copyright infringement, misappropriation, etc.) jeopardize the intellectual property of the model owners, undermines the significant cost and efforts undertaken to develop the models, and may cause other serious economic consequences. While legal remedies often one possible approach to this problem, they are very costly and often produce unsatisfactory results.

The problem of protecting learning models is not limited to addressing theft. Recently, DNN model sharing platforms have been launched to promote reproducible research results, and it is anticipated that commercial DNN model markets will arise to enable monetization of AI products and services. Indeed, individuals and companies desire to purchase and sell such models in the same way as in the current mobile application market. These opportunities create additional incentives for unauthorized entities to obtain and implement DNN models.

Given the anticipated widespread adoption and use of machine learning models (including, without limitation, DNNs), there is a significant need to find a way to verify the ownership of a machine learning model to protect the intellectual property therein and to otherwise detect the leakage of deep learning models.

Digital watermarking has been widely adopted to protect the copyright of proprietary multimedia content. Watermarking typically involves two stages: embedding and detection. In an embedding stage, owners embed watermarks into the protected multimedia. If the multimedia data are stolen and used by others, in the detection stage owners can extract the watermarks from the protected multimedia as legal evidence to prove their ownership of the intellectual property.

Recently, it has been proposed to embed watermarks in deep neural networks for DNN model protection. In this approach, watermarks are embedded into the parameters of DNN models during the training process. As a consequence, this approach to protecting a DNN model has significant constraints, notably the requirement that the watermark can only be extracted by having access to all the model parameters. This white-box approach is not viable in practice, because a stolen model would be expected to be deployed only as a service, thus preventing access to the model parameters necessary to extract the watermark. Further, model watermarking cannot prevent attackers from obtaining correct predictions from stolen models and thus cannot fully prevent intellectual property theft.

### BRIEF SUMMARY

A neural network is trained using a training data set, thereby resulting in a set of model weights, namely, a matrix X, corresponding to the trained network. According to this disclosure, the set of model weights is then modified or “locked” to produce a locked matrix X′, where the locked matrix X′ is generated by applying a key K, preferably as a Hadamard product KΘX. In one embodiment, the key K is a binary matrix {0, 1} that zeros (masks) out certain neurons in the network, thereby protecting the network. In another embodiment, the key comprises a matrix of sign values {−1, +1}. In still another embodiment, the key comprises a set of real values, e.g., a matrix R. In a preferred approach, the key is derived by applying a key derivation function to a secret value. The key K is symmetric, such that the same key used to protect the model weight matrix X (to generate the locked matrix X′) is also used to recover that matrix, e.g., by computing the Hadamard product, and thus enable access to and use of the model as it was trained.

According to a further aspect, different parts of the network (having different keys K associated therewith) are trained for different purposes, such as solving a same problem but with a first key K₁ that minimizes a loss function, and a second key K₂ that maximizes the loss function. In an alternative, the model with different keys are trained on two or more distinct data sets.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 illustrates how a local DNN model created by an owner may be stolen by a competitor to set up a plagiarized service;

FIG. 4 depicts a DNN comprising a set of layers;

FIG. 5 depicts computation of a Hadamard product;

FIG. 6 depicts the basic technique of this disclosure; and

FIG. 7 depicts a process flow of this disclosure whereby the secrecy of the machie learning model is made to depend on keying material and not on the secrecy of the training weights for the modified model.

### DETAILED DESCRIPTION OF AN ILLUSTRATIVE EMBODIMENT

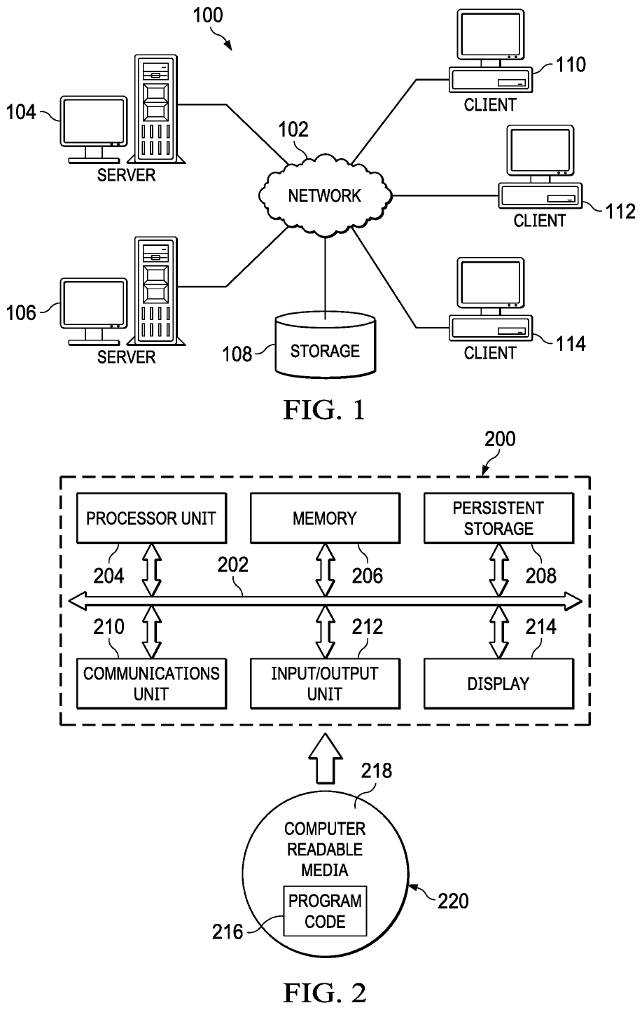

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the disclosure may be located.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor (SMP) system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java™, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

As will be seen, the techniques described herein may operate in conjunction within the standard client-server paradigm such as illustrated in FIG. 1 in which client machines communicate with an Internet-accessible Web-based portal executing on a set of one or more machines. End users operate Internet-connectable devices (e.g., desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

### Deep Neural Networks

By way of additional background, deep learning is a type of machine learning framework that automatically learns hierarchical data representation from training data without the need to handcraft feature representation. Deep learning methods are based on learning architectures called deep neural networks (DNNs), which are composed of many basic neural network units such as linear perceptrons, convolutions and non-linear activation functions. Theses network units are organized as layers (from a few to more than a thousand), and they are trained directly from the raw data to recognize complicated concepts. Lower network layers often correspond with low-level features (e.g., in image recognition, such as corners and edges of images), while the higher layers typically correspond with high-level, semantically-meaningful features.

Specifically, a deep neural network (DNN) takes as input the raw training data representation and maps it to an output via a parametric function. The parametric function is defined by both the network architecture and the collective parameters of all the neural network units used in the network architecture. Each network unit receives an input vector from its connected neurons and outputs a value that will be passed to the following layers. For example, a linear unit outputs the dot product between its weight parameters and the output values of its connected neurons from the previous layers. To increase the capacity of DNNs in modeling the complex structure in training data, different types of network units have been developed and used in combination of linear activations, such as non-linear activation units (hyperbolic tangent, sigmoid, Rectified Linear Unit, etc.), max pooling and batch normalization. If the purpose of the neural network is to classify data into a finite set of classes, the activation function in the output layer typically is a softmax function, which can be viewed as the predicted class distribution of a set of classes.

Prior to training the network weights for a DNN, an initial step is to determine the architecture for the model, and this often requires non-trivial domain expertise and engineering efforts. Given the network architecture, the network behavior is determined by values of the network parameters, θ. More formally, let D={xᵢ, [symbol] ᵢ}^{T}ᵢ₌₁ be the training data, where [symbol] ᵢ∈[0, n−1] is a ground truth label for xᵢ, the network parameters are optimized to minimize a difference between the predicted class labels and the ground truth labels based on a loss function. Currently, the most widely-used approach for training DNNs is a back-propagation algorithm, where the network parameters are updated by propagating a gradient of prediction loss from the output layer through the entire network. Most commonly-used DNNs are feed-forward neural networks, wherein connections between the neurons do not form loops; other types of DNNs include recurrent neural networks, such as long short-term memory (LSTM), and these types of networks are effective in modeling sequential data.

### Threat Model

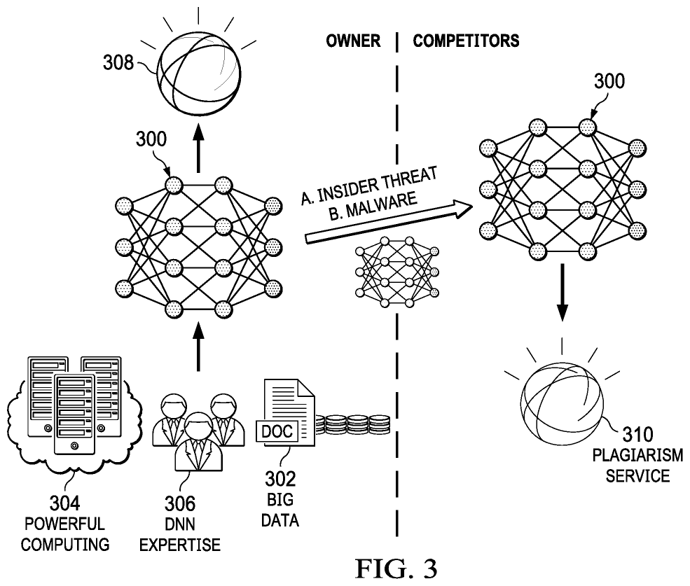

Referring now to FIG. 3, the problem of deep neural network plagiarism is depicted. On the left, an owner (or creator, developer, authorized provider, or the like) creates a production-level deep neural network 300 using a large amount of training data 302, powerful computing resources 304, and DNN human expertise 306. The owner makes that DNN available as a service 308. On the right, a competitor sets up a plagiarism service 310 by obtaining wrongful access to and possession of the DNN 300, perhaps via an insider who leaks the model, malware, fraud, or other improper means. More formally, a threat model for this scenario models two parties, a model owner O, who owns a deep neural network model m for a certain task, and a suspect S, who sets up a service t′ from model m′, while two services have similar performance t≅t′. In this context, assume that it is a goal to help owner O protect the intellectual property t of model m. Intuitively, if model m is equivalent to m′, S can be confirmed as a plagiarized service of t. An entity is deemed to have white-box access to a model if it has access to the internals of the model, such as the model parameters; in contrast, the notion of a black-box implies that an entity does not have any such access but, rather, it can only analyze an input to the model and the corresponding output produced from that input. In addition, this threat model assumes that the S can modify the model m′ but still maintain the performance of t′ such that t′≅t. There are known techniques to help owner O verify whether the service t′ comes from (i.e., utilizes) the model m, without requiring white-box access to m′.

The nomenclature used in the above-described threat model (or in this disclosure generally) is not intended to be limiting. A model owner may be any person or entity having a proprietary interest in the model, e.g., but without limitation, its creator, designer or developer. As used herein, ownership is not necessarily tantamount to a legal right, although this will be the usual scenario. Ownership may also equate to provenance, source of origin, a beneficial or equitable interest, or the like. More generally, the threat model involves first and second entities, wherein as between the two entities the first entity has the greater (legal, equitable or other permissible) interest in the model, and it is desired to determine whether the second entity has obtained access to the model in contravention of the first entity's greater interest. In a typical scenario, the second entity has copied the model without the first entity's consent.

The nature of the training data used to train the DNN of course depends on the model's purpose. As noted above, deep neural networks have been proven useful for a variety of tasks, such as image recognition, speech recognition, natural language processing, and others. For ease of explanation, the remainder of this disclosure describes a DNN used to facilitate image recognition. Thus, the training data is described as being a set of images, and typically the DNN model is a feed-forward network. Other deep learning tasks, training data sets, DNN modeling approaches, etc. can leverage the technique as well.

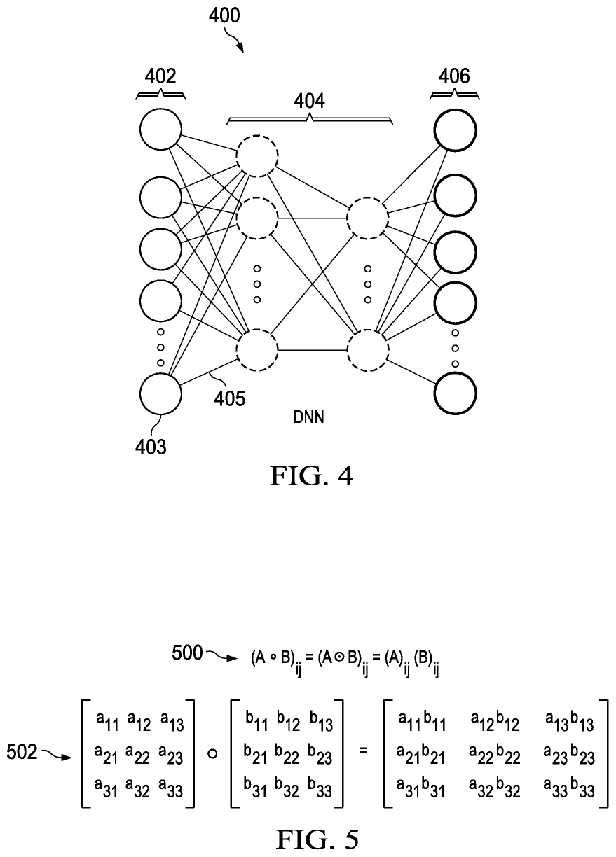

FIG. 4 depicts a representative DNN 400, sometimes referred to an artificial neural network. As depicted, DNN 400 is an interconnected group of nodes (neurons), with each node 403 representing an artificial neuron, and a line 405 representing a connection from the output of one artificial neuron to the input of another. In the DNN, the output of each neuron is computed by some non-linear function of the sum of its inputs. The connections between neurons are known as edges. Neurons and the edges typically have a weight that adjusts as learning proceeds. The weight increases or decreases the strength of the signal at a connection. As depicted, in a DNN 400 typically the neurons are aggregated in layers, and different layers may perform different transformations on their inputs. As depicted, signals (typically real numbers) travel from the first layer (the input layer) 402 to the last layer (the output layer) 404, via traversing one or more intermediate (the hidden layers) 406. Hidden layers 406 provide the ability to extract features from the input layer 402. As depicted in FIG. 4, there are two hidden layers, but this is not a limitation. Typically, the number of hidden layers (and the number of neurons in each layer) is a function of the problem that is being addressed by the network. A network that includes too many neurons in a hidden layer may overfit and thus memorize input patterns, thereby limiting the network's ability to generalize. On the other hand, if there are too few neurons in the hidden layer(s), the network is unable to represent the input-space features, which also limits the ability of the network to generalize. In general, the smaller the network (fewer neurons and weights), the better the network.

The DNN 400 is trained using a training data set, thereby resulting in generation of a set of weights corresponding to the trained DNN. As used herein, the neurons of the DNN that has been trained are sometimes referred to as “real” neurons. Real neurons may also correspond to all of the neurons of a pre-trained network.

As depicted in FIG. 4, once trained, the DNN 400 has a given topology of nodes and edges.

### Protecting Machine Learning Models

With the above as background, the technique of this disclosure is now described. In this approach, a DNN such as depicted in FIG. 4 and that an owner or provider desires to protect against misappropriation or otherwise wrongful use is secured in the following manner. A neural network is trained using a training data set, thereby resulting in a set of model weights corresponding to the trained network. In many instances the set of model weights may be represented by a matrix X, and for purposes of the following description this assumption is made. According to this disclosure, the set of model weights is then modified or “locked” to produce a locked matrix X′, where the locked matrix X′ is generated by applying a key K, preferably as a Hadamard product KΘX. The Hadamard product is a binary operation that takes the two matrices (each having the same dimension) and produces a resulting matrix of the same dimension as the operands, and wherein each element i,j in the resulting matrix is the product of elements i,j of the original two matrices. In particular, and as shown in FIG. 5, given two matrices A and B of the same dimension m×n, the Hadamard product is a matrix of the same dimension as the operands, with elements given by the function 500. The example 502 shows the Hadamard prod the 3×3 matrix A with the 3×3 matrix B. This sizing is not intended to be limiting.

In one embodiment, the key K is a binary matrix {0, 1} that zeros (masks) out certain neurons in the network, thereby protecting the network. In another embodiment, the key comprises a matrix of sign values {−1, +1}. In still another embodiment, the key comprises a set of real values, e.g., a matrix R. While masking one or more neurons using a simple key K such as described secures the model (or at least some portion thereof), a preferred approach according to this disclosure is to utilize a key that itself is generated securely. Thus, the key K may be a secret key derived by applying a key derivation function (KDF) to a given password or other secret value (a passphrase, another key, etc.). In cryptography, a KDF derives the secret key typically using a pseudorandom function, such as a keyed cryptographic hash function. The password or other secret value applied to the KDF may itself comprise a set of parameters. Preferably, the key K is symmetric, such that the same key used to protect the model weight matrix X is also useful for recovery of that matrix, e.g., by computing the Hadamard product.

Generalizing, according to this disclosure a machine learning model is secured by applying a given function or transformation (K) over a matrix of model weights, and then re-applying that transformation to cover the original model. The transformation (K) itself may be derived from another password or secret. Because the key (K) has the same dimension as the set of model weights to which it is applied and is also used to recover the original weights, the transformation can be analogized to a one-time pad (OTP). In cryptography, a one-time pad is a system in which a private key generated randomly is used only once to encrypt a message that is then decrypted by the receiver using a matching one-time pad and key.

According to a further aspect, different parts of the network (having different keys K associated therewith) can be trained for different purposes, such as solving a same problem but with a first key K₁ that minimizes a loss function, and a second key K₂ that maximizes the loss function. This example (minimizing and maximizing the loss function is just exemplary). In the alternative, the model with different keys are trained on two or more distinct data sets. For example, if G (x, θ)=y is the neural network where θ are the model parameters (weights) and x is the input, then G (x, F (K1, θ)) represents the network being trained for one function, G (x, F (K2, θ)) is then network trained for a second function, G (x, θ) is the network trained from a third function, and so forth. As a more specific example, G (x, θ) is trained to maximize the loss for training labels Y, while G (x, F (K1, θ)) is trained to minimize the loss.

As a further variant, although not required (especially if the network has additional capacity, as most do), the model itself may be modified by including one or more neurons (or one or more layers of such neurons) that are other than the real neurons in the originally trained model. The result is a modified version of the original DNN, and this modified version is referred to herein as a modified DNN. The additional neurons are embedded (sometimes referred to as being placed, injected, positioned, etc.) into the DNN such that the topology of the original DNN remains intact, albeit in a manner that is not readily ascertainable from an examination of the modified DN itself. In other words, the modified DNN itself has a topology, but the topology of the modified DNN does not expose the topology of the underlying (original DNN). In this manner, the modified DNN is sometimes said to “contain” the original DNN. In this embodiment, the key (K) may be a binary matrix (as described above), but the binary values are not necessarily random. Rather, in this embodiment, preferably either the 0's or the 1's (as the case may be) are positioned in the key matrix to correspond to the locations in the modified DNN corresponding to the additional neurons. In other words, each of the added neurons is assigned, say, a “0” value, and the locations of the actual neurons are assigned the “1” value. Then, when the key (K) is later re-applied to recover the original matrix, the Hadamard product accounts for the “0” values (and masks them) out, leaving the original matrix.

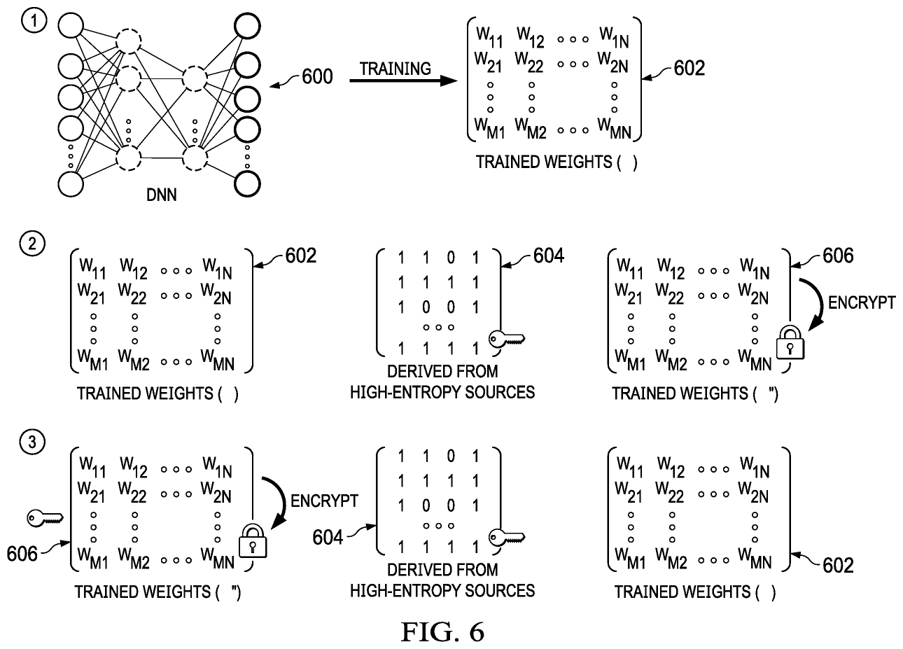

Referring now to FIG. 6, a deep neural network (DNN) 600 that is desired to be protected comprises multiple layers formed from a set of neurons. Upon training, a set of trained weights (X) 602 is generated. This is step (1). As is well-known, the model (represented by the matrix X of trained weights) thus represents a decision surface that provides a desired function ƒ(x), which is an intended behavior defined by the model. To protect this model, and according to this disclosure, at step (2) the matrix of trained weights are then secured using a key 604, thereby generating the locked matrix 606. In this example, the key 604 is a {0, 1} matrix, namely, a set of binary weights, and which are preferably derived from a high entropy source. The locked matrix (i.e., the set of modified weights) is generated as KΘX=X′, where X is the original matrix and K is the key. As noted above, invoking the key as a binary matrix is just one example embodiment. Then, and as depicted at step (3), the original matrix 602 is recoverable by computing the Hadamard product of the locked matrix 606 and the key 604.

As the example scenario in FIG. 6 shows, the key is useful to recover the original model weight matrix. In the event the locked matrix is then appropriated or otherwise obtained, the locked matrix does not reveal details of the original model itself. Accordingly, the key is required to selectively unlock the matrix and then recover the original model. In the example scenario, the key is structured as a simple data set, namely as the binary matrix K comprising binary “1” and “0” values or, more generally, first and second values. To serve as a one-time pad, the key matrix preferably has at least the same dimensionality as the matrix of weights derived from the original model (the key matrix may also have a larger dimensionality provided that the Hadamard product is produced from a portion thereof that corresponds to the dimensionality of the model weight matrix).

According to this disclosure, and in order to ensure the security of the locked matrix, the key (K) itself must be secured. The model key K is maintained confidential in many different ways. In one embodiment, the key itself is encrypted using a symmetric key. Another approach applies a private key of an asymmetric key pair to the key K. Another approach is to maintain the key (K) in a protected enclave (e.g., Intel® SGX). The enclave may comprise part of a trusted computing environment that also generates and/or processes the model. Generalizing, the K used to create the locked matrix should be protected against disclosure using secure hardware, cryptographic, or other hardware and/or software protection mechanisms.

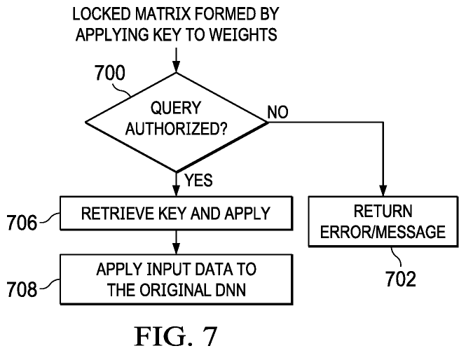

FIG. 7 depicts a process flow of a representative protection mechanism that implements FIG. 6, step (3) It assumes the generation of the original DNN using the training data set, the creation of the locked matrix and the secure storage of the key. At step 700, a test is made to determine whether a query directed to the model is authorized. If the outcome of the test is negative (e.g., because the user is not or cannot be determined to be a benign user), an error or another message is returned at step 702. The user making the request need not be made aware of this notification. If, however, the outcome of the test at step 700 is positive (e.g., because the user is determined to be benign), at step 706 the key is retrieved from secure storage and applied to the locked matrix. Typically, this operation performs a matrix multiplication (the Hadamard product) of the keying material matrix K and the matrix of the trained weights X′, thereby recovering the original weights. The resulting unlocking operation recovers the original DNN. At step 708, the input data is then applied to the original DNN, and the result is the intended behavior ƒ(x) of the original model.

The technique herein leverages Kerckhoffs's principle, namely, that the cryptosystem described herein is still secure even if everything about the system, except the model key, is publicly known or ascertainable. In effect, the model key (however formulated) is used to deactivate certain neurons when bootstrapping the model for classification.

Generalizing, upon a determination that a query directed to the model is authorized, the key is applied to the locked matrix to recover the original matrix (and thus provide an assurance that intended behavior of the DNN has not been compromised, and input data associated with the query is applied against the DNN. If, however, the query directed to the model is not authorized (for whatever reason), the input data associated with the query is applied against a model corresponding to the locked matrix, with the result being a behavior that is different from that of the network. In the latter case, the suspect user does not obtain access to the original network, and an indication may also be provided that the intellectual property in the DNN has been compromised.

As noted above, the approach herein provides a general framework to protect the DNN even if the model and its weights are public. The technique works by using the key (K) in effect to mask the true topology of the DNN, and only one who possesses or can obtain the keying material has the ability to recover the original weights, thereby obtaining the true behavior of the DNN. A model implementing the locked matrix may provide what appears to be a useful output, but it is an output that differs from that which would be provided if the original weights of the DNN are used. In this approach, attackers running input data through a model based on the locked matrix can only obtain pre-defined, fake functions from the model because they cannot distinguish which neurons are masked (or are real ones, when the additional neurons are added in the variant embodiment). In effect, the approach herein serves to deceive attackers, and protects the original model from attack (either insider-based or otherwise). By using this approach, the true weights of the DNN are concealed from any entity that does not have authorized access to the key. In the event of model theft, an attacker is unable to recover the original DNN function (and its predictions) because the key needed to unlock the original DNN weights is not ascertainable or otherwise known.

The technique herein protects the intellectual property of deep neural networks once those models are leaked or copied and deployed as online services.

One or more aspects of this disclosure may be implemented as-a-service, e.g., by a third party that performs model verification testing on behalf of owners or other interested entities. The subject matter may be implemented within or in association with a data center that provides cloud-based computing, data storage or related services.

In a typical use case, a SIEM or other security system has associated therewith an interface that can be used to issue the API queries, and to receive responses to those queries. The client-server architecture as depicted in FIG. 1 may be used for this purpose.

The approach herein is designed to be implemented on-demand, or in an automated manner.

Access to the service for model generation, training, key generation, or query processing, may be carried out via any suitable request-response protocol or workflow, with or without an API.

The functionality described in this disclosure may be implemented in whole or in part as a standalone approach, e.g., a software-based function executed by a hardware processor, or it may be available as a managed service (including as a web service via a SOAP/XML interface). The particular hardware and software implementation details described herein are merely for illustrative purposes are not meant to limit the scope of the described subject matter.

More generally, computing devices within the context of the disclosed subject matter are each a data processing system (such as shown in FIG. 2) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The scheme described herein may be implemented in or in conjunction with various server-side architectures including simple n-tier architectures, web portals, federated systems, and the like. The techniques herein may be practiced in a loosely-coupled server (including a “cloud”-based) environment.

Still more generally, the subject matter described herein can take the form of an entirely hardware embodiment, an entirely software embodiment or an embodiment containing both hardware and software elements. In a preferred embodiment, the function is implemented in software, which includes but is not limited to firmware, resident software, microcode, and the like. Furthermore, as noted above, the identity context-based access control functionality can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

In a representative embodiment, the techniques described herein are implemented in a special purpose computer, preferably in software executed by one or more processors. The software is maintained in one or more data stores or memories associated with the one or more processors, and the software may be implemented as one or more computer programs. Collectively, this special-purpose hardware and software comprises the functionality described above.

While the above describes a particular order of operations performed by certain embodiments, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, execution threads, and the like.

The techniques herein provide for improvements to another technology or technical field, e.g., deep learning systems, other security systems, as well as improvements to automation-based cybersecurity analytics.

The techniques described herein are not limited for use with a deep neural network (DNN) model. The approach may be extended to any machine learning model including, without limitation, a Support Vector Machine (SVM), a logistical regression (LR) model, and the like, that has weights, and the approach may also be extended to use with decision tree-based models.

Also, while the Hadamard product is a preferred way to generate and unlock the model weight matrix, other matrix-based computations may be used provided they respect the dimensionality requirement described.

Having described the subject matter, what we claim is as follows:

1. A method to protect a machine learning model, comprising:
receiving a set of model weights, the set of model weights structured as a matrix having a given dimensionality and having been generated as a result of training the model;
generating a key, the key having a set of values, the set of values structured as a matrix having at least the given dimensionality; and
applying the key to the set of model weights to generate a locked set of model weights, thereby securing the machine learning model.

2. The method as described in claim 1 further including:
in response to a given occurrence, selectively re-applying the key to the locked set of model weights to recover the set of model weights.

3. The method as described in claim 1 wherein the key comprises one of: a matrix of binary values, a matrix of sign values, a matrix of real number values, and a matrix of parameters generated as a result of applying a key derivation function (KDF) to a secret value.

4. The method as described in claim 1 wherein the key is applied to at least a portion of the set of model weights to generate a first behavior of the machine learning model, and wherein a second key is applied to at least some other portion of the set of model weights to generate a second behavior of the machine learning model.

5. The method as described in claim 1 wherein the key is applied to the set of model weights by computing a Hadamard product of the matrix corresponding to the set of model weights, and to the matrix corresponding to the key.

6. The method as described in claim 5 wherein the key is selectively re-applied by computing the Hadamard product of the matrix corresponding to the locked set of model weights, and to the matrix corresponding to the key.

7. The method as described in claim 1 wherein the key is a matrix of first and second values, wherein each matrix element at a location corresponding to an actual neuron in the model is assigned a first value, and wherein each matrix element at a location corresponding to a dummy neuron added to the model is assigned the second value.

8. An apparatus, comprising:
a processor;
computer memory holding computer program instructions executed by the processor to protect a machine learning model, the computer program instructions configured to:
receive a set of model weights, the set of model weights structured as a matrix having a given dimensionality and having been generated as a result of training the model;
generate a key, the key having a set of values, the set of values structured as a matrix having at least the given dimensionality; and
apply the key to the set of model weights to generate a locked set of model weights, thereby securing the machine learning model.

9. The apparatus as described in claim 8 wherein the computer program instructions are further configured to:
in response to a given occurrence, selectively re-apply the key to the locked set of model weights to recover the set of model weights.

10. The apparatus as described in claim 8 wherein the key comprises one of: a matrix of binary values, a matrix of sign values, a matrix of real number values, and a matrix of parameters generated as a result of applying a key derivation function (KDF) to a secret value.

11. The apparatus as described in claim 8 wherein the key is applied to at least a portion of the set of model weights to generate a first behavior of the machine learning model, and wherein a second key is applied to at least some other portion of the set of model weights to generate a second behavior of the machine learning model.

12. The apparatus as described in claim 8 wherein the key is applied to the set of model weights by computing a Hadamard product of the matrix corresponding to the set of model weights, and to the matrix corresponding to the key.

13. The apparatus described in claim 12 wherein the key is selectively re-applied by computing the Hadamard product of the matrix corresponding to the locked set of model weights, and to the matrix corresponding to the key.

14. The apparatus as described in claim 8 wherein the key is a matrix of first and second values, wherein each matrix element at a location corresponding to an actual neuron in the model is assigned a first value, and wherein each matrix element at a location corresponding to a dummy neuron added to the model is assigned the second value.

15. A computer program product in a non-transitory computer readable medium for use in a data processing system to protect a machine learning model, the computer program product holding computer program instructions that, when executed by the data processing system, are configured to:
receive a set of model weights, the set of model weights structured as a matrix having a given dimensionality and having been generated as a result of training the model;
generate a key, the key having a set of values, the set of values structured as a matrix having at least the given dimensionality; and
apply the key to the set of model weights to generate a locked set of model weights, thereby securing the machine learning model.

16. The computer program product as described in claim 15 wherein the computer program instructions are further configured to:
in response to a given occurrence, selectively re-apply the key to the locked set of model weights to recover the set of model weights.

17. The computer program product as described in claim 15 wherein the key comprises one of: a matrix of binary values, a matrix of sign values, a matrix of real number values, and a matrix of parameters generated as a result of applying a key derivation function (KDF) to a secret value.

18. The computer program product as described in claim 15 wherein the key is applied to at least a portion of the set of model weights to generate a first behavior of the machine learning model, and wherein a second key is applied to at least some other portion of the set of model weights to generate a second behavior of the machine learning model.

19. The computer program product as described in claim 15 wherein the key is applied to the set of model weights by computing a Hadamard product of the matrix corresponding to the set of model weights, and to the matrix corresponding to the key.

20. The computer program product escribed in claim 19 wherein the key is selectively re-applied by computing the Hadamard product of the matrix corresponding to the locked set of model weights, and to the matrix corresponding to the key.

21. The computer program product as described in claim 15 wherein the key is a matrix of first and second values, wherein each matrix element at a location corresponding to an actual neuron in the model is assigned a first value, and wherein each matrix element at a location corresponding to a dummy neuron added to the model is assigned the second value.

22. A method to protect a machine learning model having a set of weights, comprising:
generating at least first and second keys;
applying the first key to the set of weights to generate a first function;
applying the second key to the set of weights to generate a second function;
training the machine learning model against the respective first and second functions using at least a first input data set.

23. The method as described in claim 22 wherein the machine learning model is trained against the first function using the first input data set, and wherein the machine learning model is trained against the second function using a second input data set that differs from the first input data set.
